(19) United States
(12) Patent Application Publication
(10) Pub. No.: US 2007/0177373 A1
(43) Pub. Date: Aug. 2, 2007

(54) Book light

(76) Inventor: Noel E. Zeller, Harrison, NY (US)

Correspondence Address: Donald S. Dowden;Cooper & Dunham LLP, 1185 Avenue of the Americas, New York, NY, 10036, US

(21) Appl. No.: 10/928,072

(22) Filed: Aug. 27, 2004

(51) Int. Cl. F21V 33/00

(52) U.S. Cl. 362/109

(57) ABSTRACT

A book light has a base, a telescoping arm having proximal and distal ends, and a shaded light source. The proximal end of the arm is pivotally connected to the base, and the light source is pivotally connected to the distal end of the arm. The light source includes at least one and preferably two light-emitting diodes (LED's). The resulting book light seldom requires attention and sheds a light that is both brighter and more diffuse and therefore better suited for reading than the light provided by a conventional book light.

### BACKGROUND OF THE INVENTION

This invention relates to book lights and in particular to a novel and highly effective book light that provides better illumination and, in a preferred embodiment, longer service than those available heretofore.

A conventional book light illuminates a page or two of reading matter without substantially illuminating the surrounding area. This enables a user of the book light to read without disturbing those nearby. Such a device is well suited for reading in bed or while using public transportation.

Conventional book lights have added greatly to the convenience of reading while traveling or in bed; and the inventor has discovered that the illumination they provide can be further enhanced by an improvement that may also greatly extend the intervals between minor repairs or adjustments.

### SUMMARY OF THE INVENTION

One object of the invention is to enhance the illumination provided by book lights. Another is to make book lights more user-friendly by reducing the amount of minor servicing they require.

These objects and others are attained in one embodiment of the invention by providing a book light comprising a base, an arm having proximal and distal ends, and a light source. The proximal end of the arm is pivotally connected to the base, and the light source is pivotally connected to the distal end of the arm and comprises at least one light-emitting diode (LED).

In another embodiment of the invention, the light source comprises at least two light emitters, preferably both LED's.

The invention provides a number of advantages. The provision of at least two light emitters, whether LED's or another kind of emitter, increases the light otherwise available, which helps older readers especially. Despite the small size of a book light and the consequent close spacing of the light emitters, it also enables one light emitter to fill in shadows cast by the other. So the light provided is not only brighter, but also softer or more diffuse. Moreover, the use of LED's provides, in comparison to many conventional light bulbs, a high light flux in relation to the electrical current drawn. That is especially advantageous in the case of book lights that are intended, as most are, to be powered at least part of the time by batteries. In accordance with the invention, conventional batteries are good for 12 to 14 or even 20 hours of continuous service. LED's also have the advantage, in comparison to most conventional light bulbs, of an extremely long life—as much as 100,000 hours of continuous service. These innovations make a book light constructed in accordance with the invention better for reading, easier to maintain, and therefore much more desirable.

### BRIEF DESCRIPTION OF THE DRAWING

A better understanding of the objects, features and advantages of the invention can be gained from a consideration of the following detailed description, in conjunction with the appended figures of the drawing, which show several configurations of different embodiments of a book light constructed in accordance with the invention. In the drawing:

FIG. 1 is a perspective view of one embodiment of a book light constructed in accordance with the invention, the book light being in a first configuration wherein it is adapted for deployment;

FIG. 2 is a right side view of the structure of FIG. 1, the book light being in a second configuration wherein it is adapted for storage;

FIG. 3 is a top view thereof in the second configuration;

FIG. 4 is a front view thereof in the second configuration;

FIG. 5 is a rear view thereof in the second configuration;

FIG. 6 is a bottom view thereof;

FIG. 7 is a partly sectional right side view thereof in the first configuration;

FIG. 8 is a fragmentary bottom view showing a battery compartment included in a base of the book light;

FIG. 9 is a top view showing one arrangement of LED's in accordance with the invention;

FIG. 10 is a right side view showing the book light cooperating with a book;

FIG. 11 is a perspective plan view of another embodiment of a book light constructed in accordance with the invention; and

FIG. 12 is a side view of the embodiment of the invention shown in FIG. 11.

### DESCRIPTION OF THE PREFERRED EMBODIMENTS

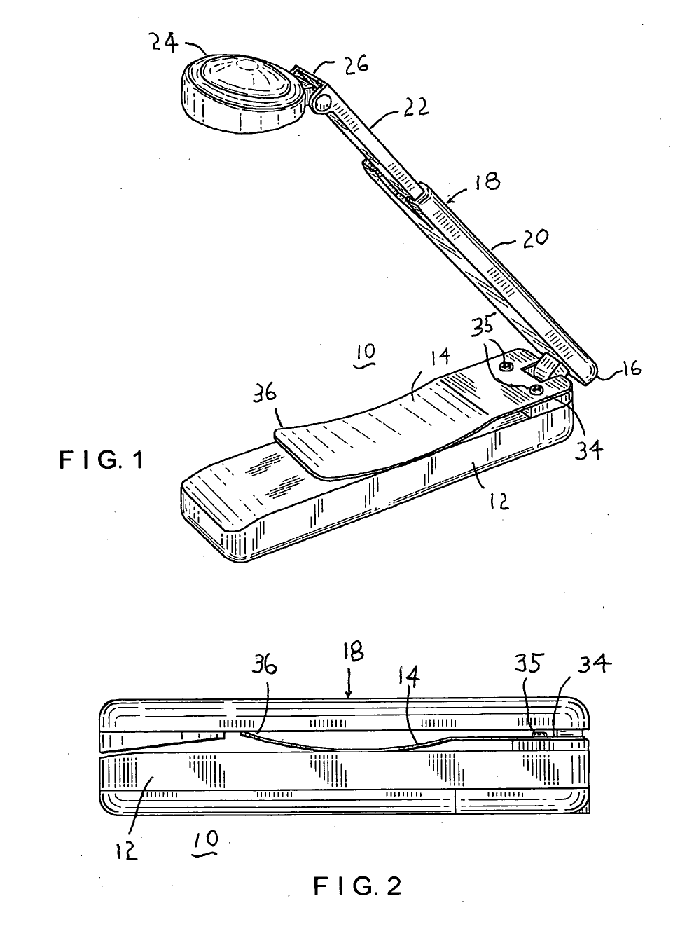

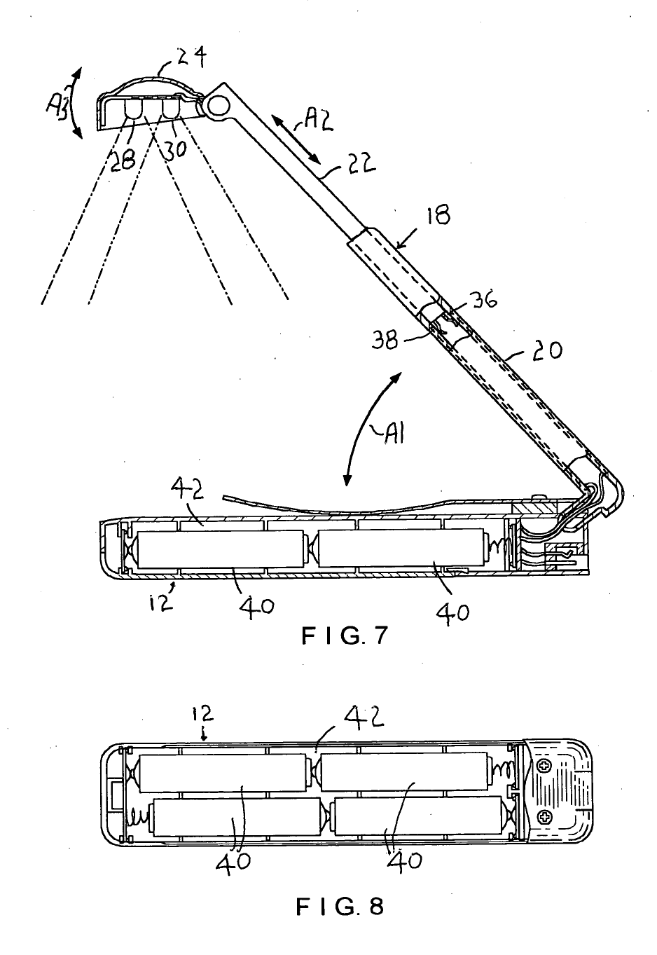

FIG. 1 shows a book light 10 constructed in accordance with one embodiment of the invention. It comprises a base 12 that has a spring clip 14 and is pivotally connected to the proximal end 16 of a straight telescoping arm 18. The pivoting movement of the arm 18 relative to the base 12 is illustrated by a curved, double-headed arrow A1 in FIG. 7.

The arm 18 comprises a first portion 20 and a second portion 22 that, in one embodiment of the invention, slides within the first portion, as illustrated by a straight, double-headed arrow A2 in FIG. 7. But for purposes of the invention, the second portion 22 can slide within the first 20, the first portion 20 can slide within the second 22, or the two portions 20, 22 can have U-shaped cross sections that open towards each other so that each arm portion 20, 22 is partly inside and partly outside the other.

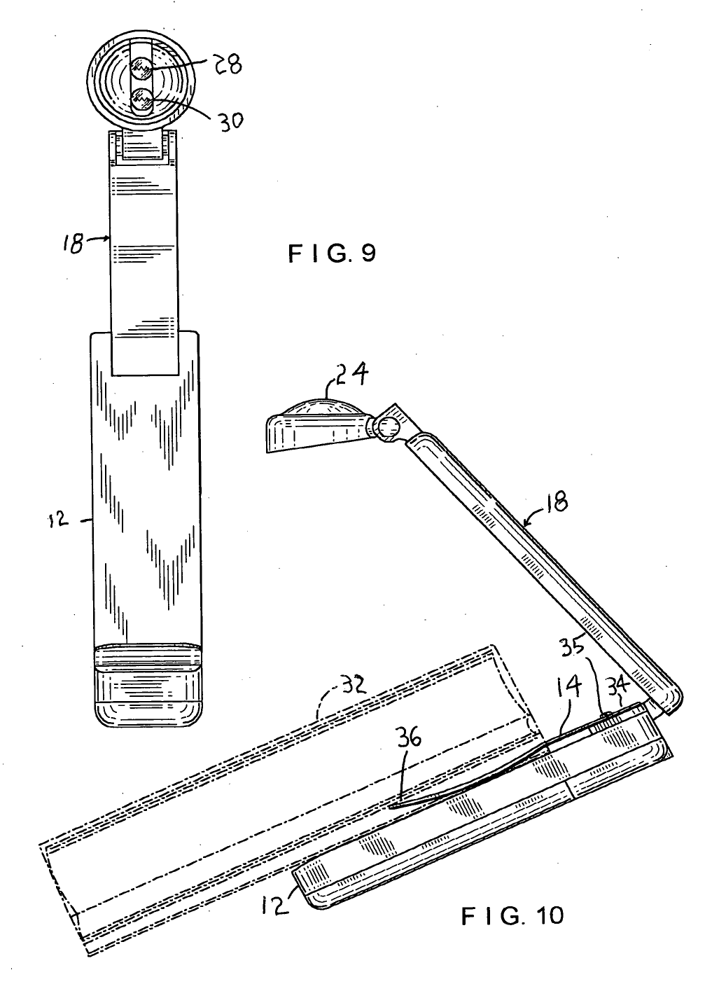

A shade 24, which can be opaque or translucent, is pivotally mounted at the distal end 26 of the second portion 22, which is also the distal end of the arm 18. The shade 24 can be pivoted, as indicated by a small, curved, double-headed arrow A3 in FIG. 7. At least one and preferably two light-emitting diodes (LED's) 28, 30 (FIGS. 7 and 9) are mounted within the shade 24. The emitted light will normally be white but can be of any desired color. The shade directs the light emitted by the LED's 28, 30 towards a book or other object to be illuminated and shields the eyes of a user of the book light 10 and those of other people in the vicinity from light glare from the LED's 28, 30.

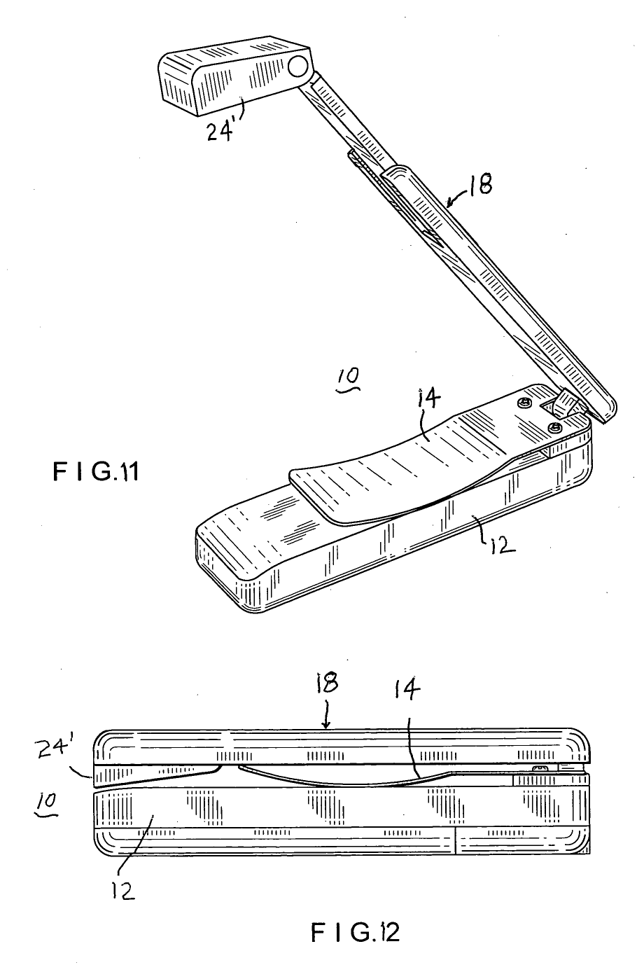

The clip 14 enables removable attachment of the book light 10 to a book 32 or other object to be illuminated, as illustrated in FIG. 10. The proximal end 34 of the clip 14 is integral with the base 12, to which it is attached by screws 35, and the distal end 36 is curved up (away from the base 12) so that it easily slips over the top of pages inserted between the clip 14 and the base 12. The clip 14 acts as a spring and securely grips the inserted pages to hold the book light 10 in a desired position relative to the book 32 or other object to be illuminated. Stable positioning of the book light in this manner is facilitated by its low weight, which can be as little as a few tens of grams.

The arm 18 is hollow and houses conductors 36, 38 (FIG. 7) that supply power from batteries 40 to the light emitters 28, 30. The conductors 36, 38 can be constructed so that they are continuous from the batteries 40 to the light emitters 28, 30 when the arm 18 is extended as in FIG. 1 but interrupted when the distal end 26 of the arm 18 is telescoped into the proximal end 16 as in FIG. 2. In that case, extending the arm 18 to the configuration shown in FIG. 1 turns the book light 10 on, and collapsing it to the configuration shown in FIG. 2 turns it off.

It is also within the scope of the invention to provide a separate switch and conductors that are continuous within the arm in all configurations of the book light 10 so that the light emitters 28, 30 can be turned on or off regardless of the extension or retraction of the arm 18. This gives an additional degree of freedom in positioning the emitters 28, 30 with respect to reading matter or another object to be illuminated.

The batteries 40 are accommodated within a battery compartment 42 formed in the base 12. Access to the battery compartment 42 is provided by a door or panel 44 (FIG. 6). The number and type of batteries 40 employed can be varied in accordance with design requirements. In FIG. 8, four AAA batteries 40 are illustrated, which are light in weight and inexpensive yet capable of giving long service—as much as 20 hours—before requiring replacement, especially since LED's do not make heavy power demands. Rechargeable batteries can optionally be provided, together with a charger that can be connected to house current for recharging the batteries. It is even possible to construct a book light in accordance with the invention that does not employ batteries but is powered solely by house current through a step-down transformer.

The pivoting movement of the arm 18 relative to the base 12 and of the shade 24 and light emitters 28, 30 relative to the arm 18, and the adjustable extension of the arm 18 give great flexibility to a book light 10 constructed in accordance with the invention. In use, it is very easy to position the emitters 28, 30 for optimal illumination of a book or another object to be illuminated while shielding the eyes of a user of the book light 10 and of those of others in the vicinity from the glare of the emitters 28, 30. A book light 10 constructed in accordance with the invention is thus ideally suited for reading in bed or for use while traveling or in any other setting where private illumination without disturbing neighbors is desired.

In one embodiment of the invention, a shade 24′ that is rectangular in plan view (FIGS. 11 and 12) cooperates with the light source 28, 30 to cast a more-or-less pyramidal light wedge. That can be an advantage where the goal is to cast a light wedge having a cross section that conforms generally to the shape of reading matter to be illuminated.

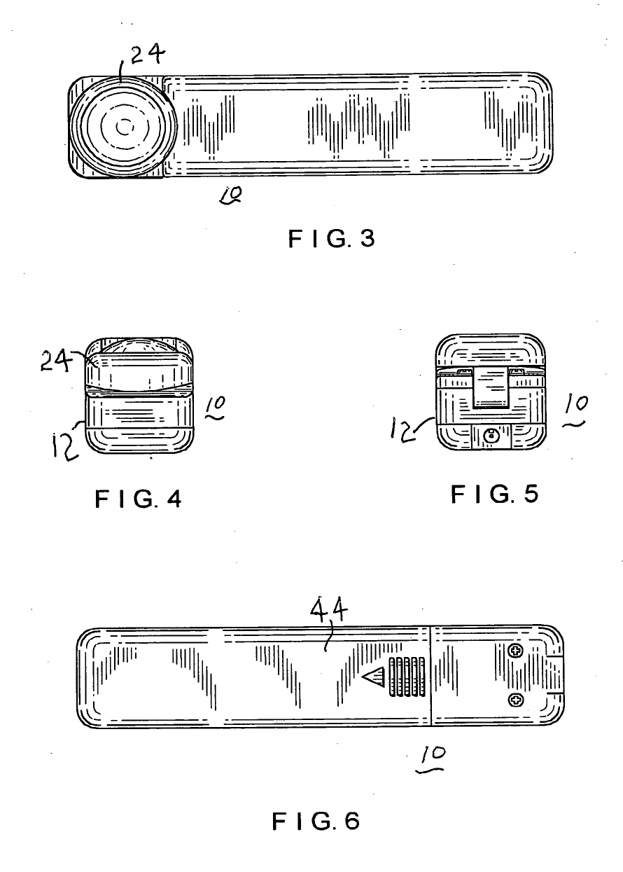

In embodiments of the invention wherein the shade is circular in plan view (FIGS. 1-10), the shade 24 cooperates with the light source 28, 30 to cast a more-or-less conical light wedge. That can be an advantage where the goal is to cast a light wedge having a cross section that is more-or-less radially symmetrical about its center.

Different patterns of side-by-side emitters 28, 30 are within the scope of the invention, including one wherein they are longitudinally displaced relative to the arm 18, as in FIG. 9; one wherein they are transversely displaced relative to the axis of the arm 18, and one wherein they are diagonally displaced relative to that axis. One can also provide three or more light emitters. In the case of three emitters, they can be arranged linearly (extending in any direction) or in a triangular configuration.

Thus there is provided in accordance with the invention a novel and highly effective book light that fully attains the objects of the invention. It enhances the illumination provided by book lights by making the light at once brighter and softer or more diffuse, thereby making reading easier and at the same time reducing eyestrain It also makes book lights more user-friendly by reducing the amount of minor servicing they require. In particular, it is unlikely that many users would ever need to replace the LED's.

The embodiments of the invention disclosed herein are merely exemplary, and many modifications and elaborations thereof will readily occur to those skilled in the art. For example, plastics, metals and other materials can be used to make book lights according to the invention, and the shape of the base 12, clip 14, arm 18 and shade 24 can be varied without exceeding the scope of the invention. The invention is defined only by the appended claims, which include all structure that falls within their scope, plus equivalents thereof.

1. A book light comprising:
a base;
an arm having proximal and distal ends; and
a light source; wherein
the proximal end of the arm is pivotally connected to the base; and
the light source is pivotally connected to the distal end of the arm and comprises at least one light-emitting diode (LED).

2. A book light according to claim 1 comprising means connected to the base for attachment of the book light to a book or the like.

3. A book light according claim 2 wherein the attachment means comprises a spring clip.

4. A book light according to claim 1 wherein the arm comprises two sections that telescope with respect to each other so that the book light can assume an extended configuration adapted for deployment of the book light or a retracted configuration adapted for storage of the book light.

5. A book light according to claim 1 comprising two LED's spaced apart from each other in side-by-side relation, whereby each can fill in shadows cast by the other to reduce eyestrain of a person employing the book light for reading or the like.

6. A book light according to claim 1 wherein the LED is capable of substantially 100,000 hours of continuous service.

7. A book light according to claim 1 comprising at least one battery for powering the light source.

8. A book light according to claim 7 comprising four AAA batteries.

9. A book light according to claim 8 wherein the batteries are capable of substantially 12 to 14 hours of continuous service.

10. A book light comprising:
a base;
an arm having proximal and distal ends;
a light source; and
a clip; wherein:
the proximal end of the arm is pivotally connected to the base;
the light source is pivotally connected to the distal end of the arm and comprises at least two bulbs;
the bulbs are spaced apart from each other in side-by-side relation, whereby each can fill in shadows cast by the other to reduce eyestrain of a person employing the book light for reading or the like;
the arm comprises two sections that telescope with respect to each other so that the book light can assume an extended configuration adapted for deployment of the book light or a retracted configuration adapted for storage of the book light and the clip provides for attachment of the book light to a book or the like.

11. A book light according to claim 10 wherein the arm is straight.
